(19) United States
(12) Patent Application Publication
(10) Pub. No.: US 2008/0180866 A1
(43) Pub. Date: Jul. 31, 2008

(54) COMBINED ARC FAULT CIRCUIT INTERRUPTER AND LEAKAGE CURRENT DETECTOR INTERRUPTER

(75) Inventor: Chi Wing Wong, Tsuen Wan (HK)

Correspondence Address: PATZIK, FRANK & SAMOTNY LTD., 150 SOUTH WACKER DRIVE, SUITE 1500, CHICAGO, IL, 60606, US

(73) Assignee: HONOR TONE, LTD., Shatin (HK)

(21) Appl. No.: 11/668,007

(22) Filed: Jan. 29, 2007

(51) Int. Cl. H02H 3/08; H02H 3/16

(52) U.S. Cl. 361/45; 361/94

(57) ABSTRACT

A combined arc fault circuit interrupter and leakage current detector interrupter. A current sensor, amplifier, and comparator are employed to detect the presence of leakage current in alternating current power conductors. Upon the detection of an amount of current leakage beyond a threshold level, a relay is opened, disconnecting a source of AC power from a power conductor being monitored, such as an appliance line cord. An arc sensor, envelope detector, amplifier, and microcontroller are employed to detect the presence of an arc fault in the alternating current power conductors. The arc fault detection algorithm implemented by the microcontroller is capable of discriminating between high frequency noise which is not caused by a parallel or series arc fault, with high frequency anomalies which are the result of arcing.

### FIELD OF INVENTION

The present invention relates, in general, to electrical conductor fault detection, and, specifically, to the detection of arc faults and leakage current faults in alternating current power conductors.

### DESCRIPTION OF RELATED ART

The National Electrical Code (NEC) is a widely followed safety standard regarding electrical wiring and equipment. Many state and local governments in the United States have mandated compliance with the NEC.

Since the year 2002, the NEC has required that single-phase cord-and-plug-connected room air conditioners be provided with factory-installed Leakage Current Detection and Interruption (LCDI) and Arc Fault Circuit Interrupter (AFCI) protection. The LCDI or AFCI protection is required to be an integral part of the attachment plug, or be located in the power supply cord within 300 millimeters, or 12 inches, of the attachment plug.

AFCI devices are designed to provide protection against parallel arcing, series arcing, or both parallel and series arcing. A series arc is a break in a single conductor where the arcing takes place between the broken conductor ends. A parallel arc is from line-to-line or line-to-ground. When an arc fault is detected, the AFCI device disconnects the appliance cord from the source of AC power.

AFCI devices typically monitor an AC power line for anomalies in the line which may be characteristic or indicative of an arc fault. However, not all anomalies are characteristic of an arc fault, but are instead “normal” noise introduced into the AC power line as the result of the use of a dimmer switch or various electrical equipment.

LCDI are designed to prevent electrical shock, by detecting the leakage of current from the line or neutral conductors of the AC power cord. If leakage is detected in either conductor, the LCDI device disconnects the appliance cord from the source of AC power.

In view of the NEC and its widespread adoption, there is a significant need for AFCI and LCDI devices, particularly when such devices are integral with the power plug of a line cord of a room air conditioner.

Accordingly, it is an object of the present invention to provide a combined AFCI/LCDI device which is integral to the power plug of a corded home appliance, such as a room air conditioner.

It is another object of the present invention to provide a method for detecting electrical arcing in an alternating current carrying power conductor, wherein the method accurately discriminates between anomalies in the electrical power line-which are the result of actual arcing, versus anomalies with are not the result of arcing, such as may be caused by the presence of a dimmer switch or other devices.

It is yet another object of the present invention to provide an apparatus for detecting electrical arcing in an alternating current power line, wherein the apparatus accurately discriminates between anomalies in the electrical power line which are the result of true arcing, versus anomalies with are not the result of arcing, such as may be caused by the presence of a dimmer switch.

These and other objects and features of the present invention will become apparent in view of the present specification, drawings, claims and abstract.

### BRIEF SUMMARY OF INVENTION

The present invention comprises a method for detecting electrical arcing in an alternating current power line. A digital signal is produced that is indicative of a presence of detected high frequency variations in the alternating current power line. The digital signal is analyzed for the presence of at least two different criteria indicative of potential electrical arcing in the alternating current power line. An arc fault signal is generated when at least two of the at least two different criteria indicative of potential electrical arcing are determined to be present in the digital signal.

Analyzing the digital signal for the presence of at least two different criteria indicative of potential electrical arcing in the alternating current power line may include analyzing the digital signal for the presence of at least three, or at least four different criteria indicative of potential electrical arcing in the alternating current power line.

The digital signal that is analyzed a plurality of pulses. The analysis of the digital signal includes analyzing a quantity of pulses occurring within a predetermined window of time to determine if the quantity of pulses meets or exceeds a predetermined threshold quantity.

The analysis of the digital signal further includes analyzing a plurality of adjacent pulses to determine if they have substantially different pulse widths. The analysis of the digital signal further includes analyzing a plurality of adjacent pulses to determine if they have substantially different intervals between adjacent pulses. The analysis of the digital signal further includes adding durations of intervals between a plurality of adjacent pulses together to determine if an interval duration summation exceeds a predetermined threshold.

In a preferred embodiment, the present invention comprises a method for detecting both electrical arcing and leakage current in an alternating current power line, by also detecting the occurrence of a leakage current fault in the alternating current power line.

The present invention also comprises an apparatus for detecting electrical arcing in an alternating current power line. The apparatus includes an arc sensor, a digital signal generator circuitry operably coupled to the arc sensor and generating at least one digital signal indicative of a presence of high frequency variations in the alternating current power line, and an analyzer operably coupled to the to the digital signal generator and capable of determining the presence of at least two different criteria indicative of potential electrical arcing in the alternating current power line. The analyzer generates an arc fault signal when at least two of the at least two different criteria indicative of potential electrical arcing are determined by the analyzer to be present in the digital signal. In a preferred embodiment, the apparatus further includes a leakage current fault detector for detecting the leakage of current from the alternating current power line.

### BRIEF DESCRIPTION OF THE SEVERAL VIEWS OF THE DRAWINGS

FIG. 1 is a block diagram of the present AFCI/LCDI apparatus;

FIG. 2 is a schematic diagram of the present AFCI/LCDI apparatus;

FIG. 3 is a flow chart of a portion of the present arc fault detection method, implemented by the microcontroller of the present AFCI/LCDI apparatus;

FIG. 4 is a flow chart of a portion of the present arc fault detection method, implemented by the microcontroller of the present AFCI/LCDI apparatus;

FIG. 5 is waveform graph of voltage in a monitored AC power line under arcing conditions;

FIG. 6 is a waveform graph of a digital signal produced by a portion of the present AFCI/LCDI apparatus in response to the monitored AC power line under the arcing conditions depicted in FIG. 5;

FIG. 7 is a waveform graph of voltage in a monitored AC power line showing variations in the normal sinusoidal AC waveform resulting from the use of a dimmer switch in association with the AC power line; and

FIG. 8 is a waveform graph of a digital signal produced by a portion of the present AFCI/LCDI apparatus in response to the monitored AC power line under conditions depicted in FIG. 7.

### DETAILED DESCRIPTION OF INVENTION

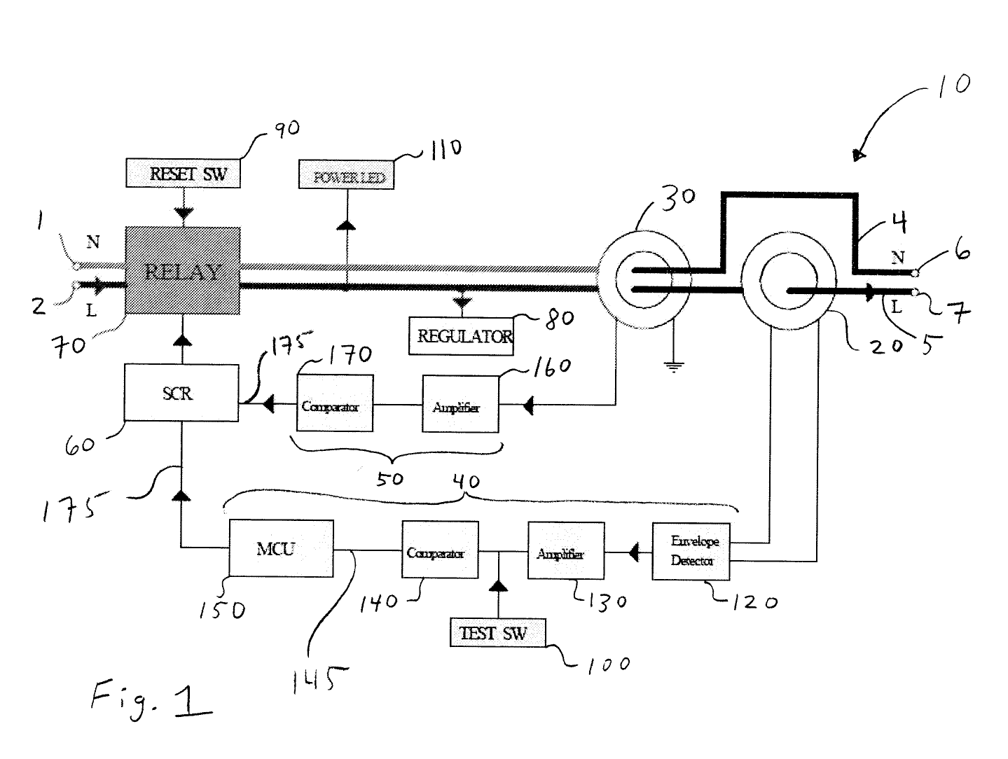

The present AFCI/LCDI apparatus 10 is shown in FIG. 1 as comprising arc sensor 20, current sensor 30, arc detection circuitry 40, leakage current detection circuitry 50, silicon-controlled rectifier (SCR) 60, relay 70, DC power supply, or regulator 80, reset switch 90, test switch 100, and power indicating light emitting diode (LED) 110.

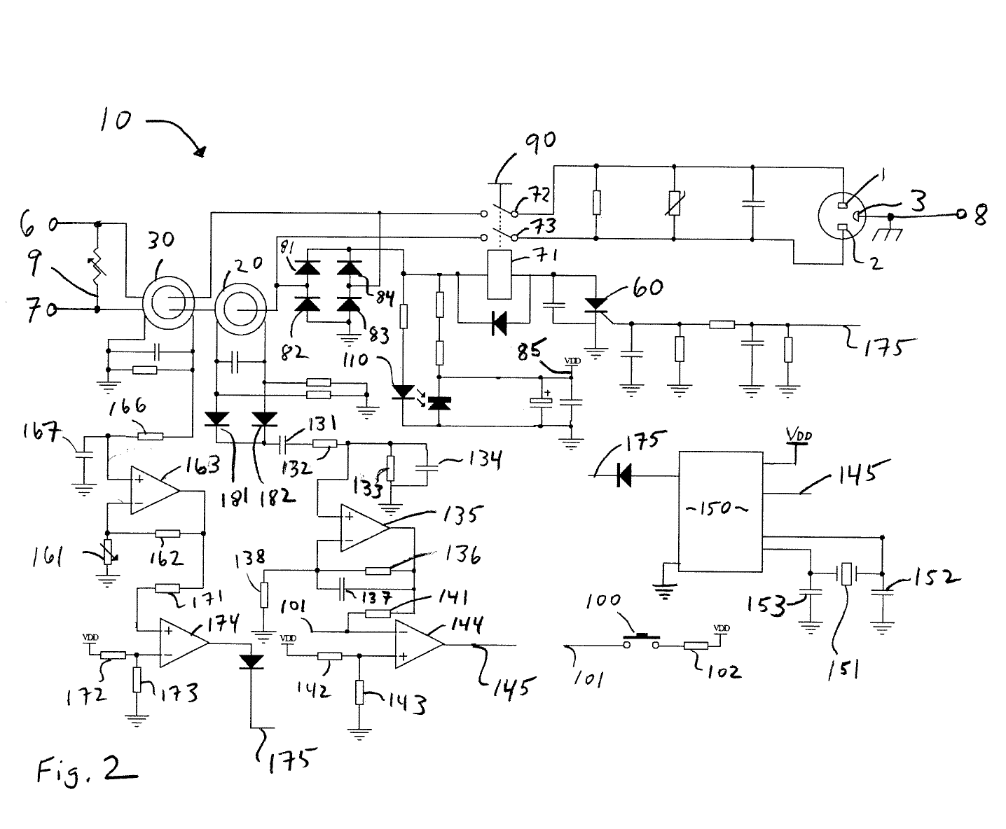

In a preferred embodiment, the apparatus is entirely contained within a relatively compact, insulating housing that serves as the power plug connected to the power cord of a household appliance, such as a room air conditioner. The power plug includes three male prongs extending from the housing to mate with a conventional female alternating current (AC) power outlet. In particular, prong 1 corresponds to the neutral portion of the AC power, prong 2 corresponds to the line (sometimes referred to as live, phase, hot or active) portion of the AC power, and prong 3 (shown in FIG. 2) corresponds to the earth ground portion. Connectors 6, 7, and 8 (shown in FIG. 2) permit connection of the neutral, line and earth ground conductors of the appliance cable, respectively, and may be in the form, for example, of screw-down terminals. The insulated housing may further include a strain relief clamp or grommet for use in association with the appliance cable.

In addition to prongs 1, 2 and 3, portions of reset switch 90 and test switch 100 preferably protrude through corresponding openings in the housing, to permit manual operation of these switches. In addition, power indicating LED 110 is preferably visible through a corresponding window or aperture in the housing. All of the AFCI/LCDI circuitry are preferably contained within a single printed circuit board carried within the housing.

In an alternative embodiment, the AFCI/LCDI circuitry and housing may be coupled “in-line”, as a portion of the power cord, between the AC power plug and the home appliance. In this embodiment, prongs 1, 2 and 3 are replaced with suitable connectors for attachment to a power cord, similar to connectors 6, 7 and 8.

Both arc sensor 20 and current sensor 30 preferably comprise zero-phase current transformers, each constructed of a conducting wire coil wound around the circumference of an annular core, all encased within an insulated casing. The core may be constructed from an 80% nickel-iron permalloy, exhibiting high magnetic permeability, low coercivity, near zero magnetostriction, an magnetoresistive characteristics. As shown in FIG. 1, both the line and neutral conductors of the AC power line to be monitored are passed through a central aperture, or bore, of current sensor 30, while only the line conductor is passed through a central aperture of arc sensor 20, before both conductors are coupled to relay 70.

Current sensor 30 accordingly operates as a differential sensor, detecting differences in current carried through the line and neutral conductors. The output of current sensor 30, a voltage indicative of the differential current, is amplified by amplifier 160. Comparator 170 compares the output of amplifier 160 to a predetermined reference voltage. If the output of amplifier 160 exceeds the reference voltage, comparator 170 outputs an OFF signal 175 to SCR 60. SCR 60 may comprise, for example, a conventional triac device. SCR 60, in turn, drives relay 70, causing it to switch from its normally closed position to its open, latched position. Relay 70 is a double pole single throw (DPST) switch, and SCR 60 accordingly causes both switches of relay 70 to simultaneously open. This, in turn, simultaneously breaks the line conductor connection between prong 2 and connector 7, and the neutral conductor connection between prong 1 and connector 6. Relay 60 includes a mechanical latching mechanism which, once the relay is tripped open, maintains the DPST switch in an open, nonconducting orientation until reset switch 90 is manually actuated. Other latching mechanisms, such as a magnetic latch, may alternatively be used.

Arc sensor 20 responds to high frequency transient current in the line conductor. The output of arc sensor 20 is rectified and then fed to envelope detector 120, which reshapes the signal, and filters out ripple. The output of envelope detector 120 is amplified by amplifier 130. Comparator 140 compares the output of amplifier 130 to a predetermined reference voltage. The output of comparator 140 is thus a pulsed digital signal 145 that is indicative of the occurrence of high frequency variations in the line conductor. These high frequency variations are anomalies to the otherwise smooth, sinusoidal voltage of the line conductor. Test switch 100 effectively overrides the output of amplifier 130 and, when manually depressed, forces comparator 140 to output a constantly asserted, rather than a pulsed signal to MCU 150. This, in turn, is interpreted by MCU 150 as being a request to test the AFCI/LCDI device, causing MCU 150 to emit an OFF signal 175 to SCR 60.

As shown in FIG. 1, pulsed digital signal 145 is fed to an input port of microcontroller unit (MCU) 150. MCU 150 may be any suitable microprocessor or microcontroller, preferably with on-chip read-only and random access memory for program and data storage, respectively. MCU 150 operates as an analyzer, continuously analyzing pulsed digital signal 145 for the presence a plurality of characteristics which are indicative of an arcing condition, or an arc fault occurring in the power line that is being monitored by the present AFCI/LCDI apparatus. If MCU 150 determines that an arc fault has occurred, it issues an OFF signal 175 to SCR 60.

AFCI/LCDI apparatus 10 is shown in further detail in FIG. 2. In FIG. 2, resistors and variable resistors are generally depicted using the European and International Electrotechnical Commission symbol convention, rather than the United States and Japanese symbol convention.

As shown in FIG. 1, variable resistor 9 permits the load across the line and neutral conductors to be manually adjusted. Regulator or DC power supply 80 (FIG. 1) is shown as comprising a full wave bridge rectifier, constructed of diodes 81, 82, 83 and 84. The output of the DC power supply is Vdd 85, a 5-volt supply powering, amongst other components, power indicating LED 110, MCU 150 and operational amplifiers 135, 144, 163 and 174.

Amplifier 160 (FIG. 1) is shown in FIG. 2 as comprising variable resistor 161, resistor 162, operational amplifier 163, resistor 166 and capacitor 167. Variable resistor 161 permits fine adjustment of the output of amplifier 160. Comparator 170 (FIG. 1) is shown in FIG. 2 as comprising resistors 171, 172, 173 and operational amplifier 174.

Relay 70 (FIG. 1) is shown in FIG. 2 as comprising solenoid 71, and switches 72 and 73, having a common throw. Solenoid 71 contains an armature which is normally in the extended position. When activated, SCR 60 energizes the coil of solenoid 71, causing a portion of the armature to retract within the coil. This, in turn, opens switches 72 and 72, causing them to remain latched in an open position until reset switch 90 is manually activated.

As shown in FIG. 2, the output of arc sensor 20 is rectified by diodes 181, 182, and the rectified output is fed to amplifier 130 (FIG. 1), comprising capacitor 131 and 134, resistors 132 and 133, and operational amplifier 135. The output of amplifier 130 is fed to comparator 140 (FIG. 1), comprising resistors 141, 142 and 143, and operational amplifier 144. Pull-up resistor 102 permits test switch 100 to pull up the reference voltage to comparator 144 at conductor 101, forcing a constantly asserted digital signal 145 to be input to MCU 150.

Crystal 151 and capacitors 152 and 153 establish an appropriate clock frequency for MCU 150. MCU 150 repeatedly samples digital input 145, and analyzes the signal for adjacent pulses having characteristics which are considered to be indicative of an arc fault condition in the power line being monitored. When such a condition is deemed to exist by the software or firmware programming executed by MCU 150, MCU 150 emits OFF signal 175, which, in turn, causes SCR 60 to trip relay 70. As a result, relay 70 can be tripped to the open position by either an output of MCU 150, when an arc fault condition is deemed to exist, or the output of leakage current detection circuitry 50, when excessive current leakage is detected.

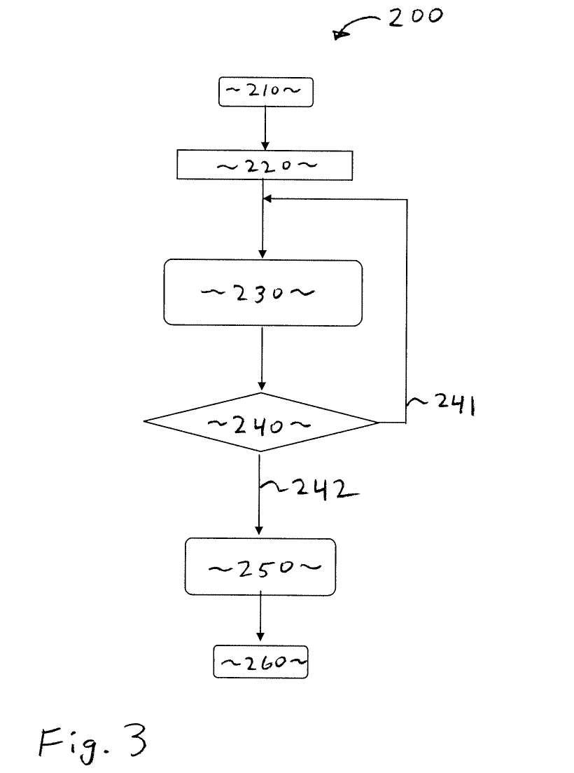

The top level algorithm 200 executed by the MCU is shown in FIG. 3. In step 210, a power-on condition is detected by the MCU. Next, program initialization 220 is performed, including the clearing of random access memory. MCU may perform an internal self-test at this time. Next, the arc fault analysis function 230 is performed. In step 240, a test is made to determine if an arc fault was detected by arc fault analysis function 230, as indicated by a Boolean flag set by the function. If not, branch 241 is taken, and the arc fault analysis function 230 is again performed. If, however, an arc fault was detected by arc fault analysis function 230, branch 242 is taken. In step 250, an OFF signal is emitted on an appropriate output pin of the MCU, causing the solenoid to energize and, in turn, causing the relay contacts to transition from the closed, conducting position to the open and latched, nonconducting position. Processing ends in exit step 260.

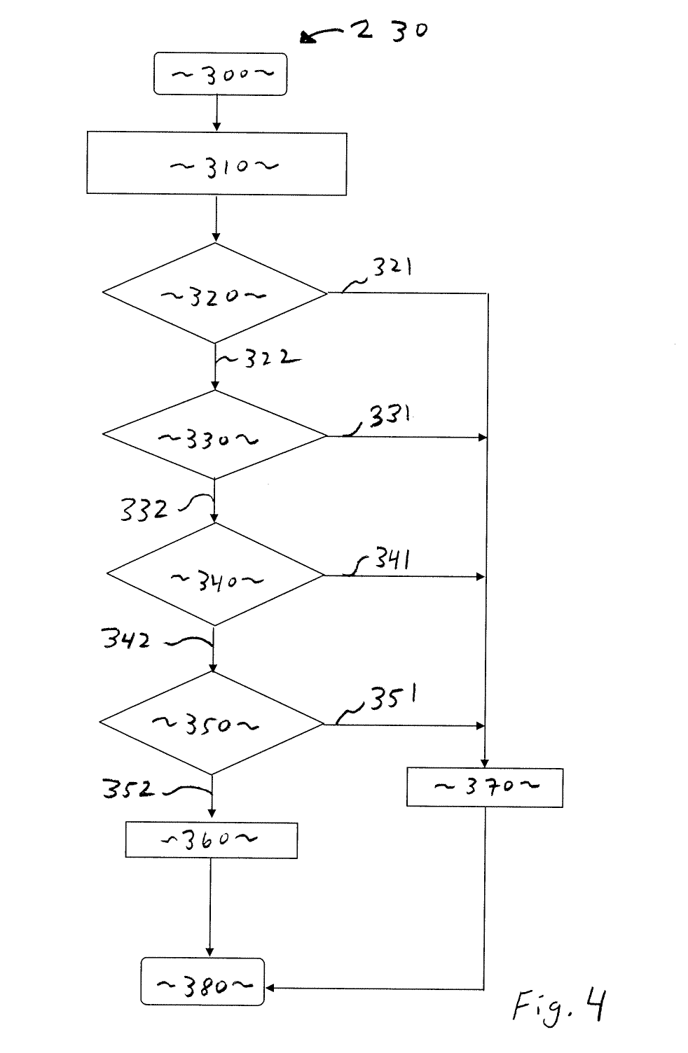

Arc fault analysis function 230 is shown in further detail in FIG. 4. Upon function entry 300, a sample of the pulsed digital signal 145 output from comparator 140 (FIG. 1) is taken by the MCU and stored in internal random access memory, in the form of a “sliding window” of such samples, analogous to a first-in, first-out queue of such samples taken over time. This permits a snapshot of the pulsed digital signal over the immediately prior 125 milliseconds to be reviewed and analyzed by the MCU.

In step 320, a test is made to determine if a first criteria indicative of potential electrical arcing in the alternating current power line has occurred. In particular, a test is made to determine if at least four pulses have occurred in the pulsed signals sampled by the MCU over the last 125 milliseconds, indicating at least four anomalous, high frequency events in the otherwise sinusoidal signal of the line conductor. Four pulses is a predetermined threshold quantity of pulses considered to be a criterion which may be indicative of electrical arcing. If not, no arc fault condition is deemed to have occurred, and branch 321 is taken to 370, where prior arc memory status variables are cleared in preparation for the next round of arc fault analysis. The arc fault analysis function exits in step 380.

If at least four pulses have occurred in the last 125 milliseconds, transition 322 is taken to step 330. In step 330, a test is performed to determine if a second criteria indicative of potential electrical arcing in the alternating current power line has occurred. In this test, the intervals T1, T2, T3 . . . Tn (FIGS. 6, 8) between adjacent pulses are added together to form an interval duration summation. If the interval duration summation does not exceed a predetermined threshold of 50 milliseconds, no arc fault condition is deemed to have occurred, and transition 331 is taken to step 370. 50 milliseconds is a threshold duration value that is considered to be a criterion which may be indicative of electrical arcing.

Otherwise, two criteria indicative of potential electrical arcing in the alternating current power line are now deemed to have occurred, and transition 332 is taken to step 340. In step 340, the individual pulse widths w1, w2, w3 . . . wn of all of the pulses sampled over the last 125 milliseconds are compared to each other. If all of the pulses are substantially similar in width, no arc fault condition is deemed to have occurred, and transition 341 is taken to step 370.

Otherwise, if all of the pulse widths are substantially different or dissimilar in duration, three criteria indicative of potential electrical arcing in the alternating current power line are now deemed to have occurred, and transition 342 is taken to step 350. In step 350, the intervals T1, T2, T3 . . . Tn (FIGS. 6, 8) between adjacent pulses sampled over the last 125 milliseconds are compared to each other. If all of the pulse intervals are substantially similar to each other, no arc fault condition is deemed to have occurred, and transition 351 is taken to step 370.

Otherwise, if the pulse interval times are substantially different or dissimilar, four criteria indicative of potential electrical arcing in the alternating current power line are now deemed to have occurred, and transition 352 is taken to step 360. Upon all four of the above-identified criteria being met for the same 125 milliseconds of sampled data derived from the arc sensor, an arc fault in the power line is deemed to have occurred. Accordingly, in step 360, a Boolean variable in random access memory is set, indicating that an arc fault is considered to have occurred in the alternating current power line that is being monitored. Transition is taken to step 380, where the current iteration of arc fault analysis processing 230 ends.

Although, in a preferred embodiment, the presence of all four of the above-described criteria are necessary conditions for an arc fault to have occurred, it is also contemplated that a combination of fewer than all four conditions being met may result in an arc fault being deemed to have occurred, such as, for example, any of the individual criterion identified above, any combination of any two of the above-identified criteria, or any combination of any three of the above-identified criteria being met.

A waveform diagram showing a monitored power line under arcing conditions is shown in FIG. 5, with voltage plotted along vertical axis 501 and time plotted along horizontal axis 502, showing approximately 125 milliseconds of data from vertical axis 501 to reference line 509. High frequency variations in the normally sinusoidal wave of the AC power line, potentially indicative of the presence of arcing, are shown at positions 503, 504, 505, 506, and 507.

A waveform diagram showing the pulsed digital signals 145 (FIGS. 1 and 2) produced by the arc detection circuitry and output by comparator 140, corresponding to a monitored AC power line having the characteristics of FIG. 5 passing through the aperture of arc sensor 20, is shown in FIG. 6, with voltage plotted along vertical axis 601 and time plotted along horizontal axis 602, showing approximately 125 milliseconds of data from vertical axis 601 to reference line 609. Referring to FIGS. 5 and 6, high frequency variation 503 causes the apparatus to produce a digital signal pulse having a pulse width of w1. High frequency variation 504 causes the apparatus to produce a digital signal pulse having a pulse width of w2. High frequency variation 505 causes the apparatus to produce a digital signal having a pulse width of w3. High frequency variation 506 causes the apparatus to produce a digital signal having a pulse width of w4. High frequency variation 507 causes the apparatus to produce a digital signal having a pulse width of wn. In FIG. 6, the interval between pulses w1 and w2 is designated T1. The interval between pulses w2 and w3 is designated T2. The interval between pulses w3 and w4 is designated T3. The interval between pulses w4 and wn is designated Tn.

In FIG. 6, five digital pulses are shown occurring within the 125 millisecond period, or window. The sum of the durations, or pulse widths w1 through wn of these five digital pulses exceed 50 milliseconds. The pulse widths w1 through wn are not substantially similar to each other, but are rather substantially dissimilar and non-uniform, with w3 being the longest duration, w1 and wn being of lesser duration, and w2 and w4 being of still lesser duration. The intervals between pulses T1 through Tn are also not substantially similar to each other, but are rather substantially dissimilar and non-uniform, with T3 being the longest interval, t2 being the next longest, Tn being the next longest, and T1 being the shortest interval. As can be seen, all four of the criteria indentified above as being indicative of potential electrical arcing in the alternating current power line are all present in the digital waveform of FIG. 6. As a result, the MCU, executing the algorithm of FIGS. 3 and 4 to perform the analysis of the digital pulses derived from the arc sensor, will issue an OFF signal to the SCR, opening the relay and disconnecting the line and neutral conductors of an appliance line cord attached to the terminals of the AFCI/LCDI apparatus from the prongs of the apparatus which, in turn, are plugged into an AC power source.

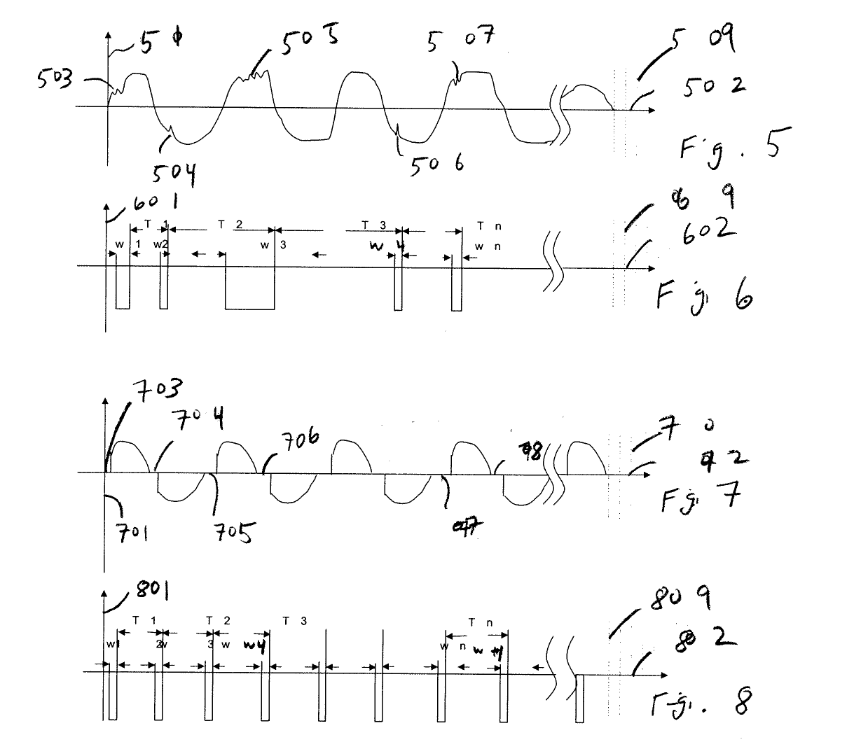

A waveform diagram showing a monitored power line displaying high frequency variations, but which is not under actual arcing conditions, is shown in FIG. 7. An AC power line may exhibit such high frequency variations when, for example, a dimmer switch is coupled in-line with the AC power source. In FIG. 7, voltage is plotted along vertical axis 701 and time is plotted along horizontal axis 702, showing approximately 125 milliseconds of data from vertical axis 701 to reference line 709. High frequency variations in the normally sinusoidal wave of the AC power line, which are not in this case indicative of the presence of arcing, are shown at several positions including positions 703, 704, 705, 706, 707 and 708.

Another waveform diagram showing the pulsed digital signals 145 (FIGS. 1 and 2) produced by the arc detection circuitry and output by comparator 140, corresponding to a monitored AC power line having the characteristics of FIG. 7 passing through the aperture of arc sensor 20, is shown in FIG. 8, with voltage plotted along vertical axis 801 and time plotted along horizontal axis 802, showing approximately 125 milliseconds of data from vertical axis 801 to reference line 809. Referring to FIGS. 7 and 8, high frequency variation 703 causes the apparatus to produce a digital signal pulse having a pulse width w1. High frequency variation 704 causes the apparatus to produce a digital signal having a pulse width of w2. High frequency variation 705 causes the apparatus to produce a digital signal having a pulse width of w3. High frequency variation 706 causes the apparatus to produce a digital signal having a pulse width of w4. High frequency variation 707 causes the apparatus to produce a digital signal having a pulse width of wn. High frequency variation 708 causes the apparatus to produce a digital signal having a pulse width of wn+1. In FIG. 8, the interval between pulses w1 and w2 is designated T1. The interval between pulses w2 and w3 is designated T2. The interval between pulses w3 and w4 is designated T3. The interval between pulses wn and wn+1 is designated Tn.

In FIG. 8, at least nine digital pulses are shown occurring within the 125 millisecond period, or window, exceeding the predetermined threshold of four pulses. As the duty cycle of the asserted digital signal shown in FIG. 8 does not exceed 40 percent, the sum of the durations, or pulse widths w1 through wn+1 of these digital pulses does not exceed the predetermined threshold of 50 milliseconds. The pulse widths w1 through wn are all substantially uniform and similar to each other. The intervals between pulses T1 through Tn are also likewise all substantially uniform and substantially similar to each other. As can be seen, all four of the criteria identified above as being indicative of potential electrical arcing in the alternating current power line are not all collectively present in the digital waveform of FIG. 8. In particular, only the first of the four criteria have been met. As a result, the MCU, executing the algorithm of FIGS. 3 and 4 to perform the analysis of the digital pulses derived from the arc sensor, will not issue any OFF signal to the SCR as a result of its analysis of the digital waveform of FIG. 8, and the line and neutral conductors of an appliance line cord attached to the terminals of the AFCI/LCDI apparatus will accordingly remain in electrical contact with the prongs of the apparatus and, in turn, with the AC power source, even in the presence of high frequency anomalies in the monitored AC power line, since these high frequency variations are the result of the presence of a dimmer switch in line with the AC power source, and not any arcing of the line cord conductors. The MCU algorithm, and the AFCI/LCDI device, overall, is thus capable of accurately discriminating between high frequency variations and anomalies in the AC power signal which are the result of actual arcing conditions, versus those which are not the result of arcing conditions and, accordingly, which should not result in the triggering of a relay to disconnect a power cord and appliance from an AC power source.

It will be understood that modifications and variations may be effected without departing from the spirit and scope of the present invention. It will be appreciated that the present disclosure is intended as an exemplification of the invention and is not intended to limit the invention to the specific embodiments illustrated and described. The disclosure is intended to cover, by the appended claims, all such modifications as fall within the scope of the claims.

I claim:

1. A method for detecting electrical arcing in an alternating current power line, comprising the steps of:
producing a digital signal indicative of a presence of high frequency variations in the alternating current power line;
analyzing the digital signal for the presence of at least two different criteria indicative of potential electrical arcing in the alternating current power line; and
generating an arc fault signal when at least two of the at least two different criteria indicative of potential electrical arcing are determined to be present in the digital signal.

2. The invention according to claim 1 wherein the step of analyzing the digital signal for the presence of at least two different criteria indicative of potential electrical arcing in the alternating current power line comprises analyzing the digital signal for the presence of at least three different criteria indicative of potential electrical arcing in the alternating current power line.

3. The invention according to claim 1 wherein the step of analyzing the digital signal for the presence of at least two different criteria indicative of potential electrical arcing in the alternating current power line comprises analyzing the digital signal for the presence of at least four different criteria indicative of potential electrical arcing in the alternating current power line.

4. The invention according to claim 1 wherein the digital signal comprises a plurality of pulses, and the step of analyzing the digital signal for the presence of at least two different criteria indicative of potential electrical arcing in the alternating current power line includes the substep of analyzing a quantity of pulses occurring within a predetermined window of time to determine if the quantity of pulses meets or exceeds a predetermined threshold quantity.

5. The invention according to claim 1 wherein the digital signal comprises a plurality of pulses, and the step of analyzing the digital signal for the presence of at least two different criteria indicative of potential electrical arcing in the alternating current power line includes the substep of analyzing a plurality of adjacent pulses to determine if they have substantially non-uniform pulse widths.

6. The invention according to claim 1 wherein the digital signal comprises a plurality of pulses, and the step of analyzing the digital signal for the presence of at least two different criteria indicative of potential electrical arcing in the alternating current power line includes the substep of analyzing a plurality of adjacent pulses to determine if they have substantially non-uniform intervals between adjacent pulses.

7. The invention according to claim 1 wherein the digital signal comprises a plurality of pulses, and the step of analyzing the digital signal for the presence of at least two different criteria indicative of potential electrical arcing in the alternating current power line includes the substep of adding durations of intervals between a plurality of adjacent pulses together to determine if an interval duration summation exceeds a predetermined threshold.

8. The invention according to claim 1, wherein the method for detecting electrical arcing in an alternating current power line comprises a method for detecting both electrical arcing and leakage current in an alternating current power line, the method further comprising the step of detecting the occurrence of a leakage current fault in the alternating current power line.

9. An apparatus for detecting electrical arcing in an alternating current power line, comprising:
an arc sensor sensor;
a digital signal generator circuitry operably coupled to the arc sensor and generating at least one digital signal indicative of a presence of high frequency variations in the alternating current power line; and
an analyzer operably coupled to the to the digital signal generator and capable of determining the presence of at least two different criteria indicative of potential electrical arcing in the alternating current power line, the analyzer generating an arc fault signal when at least two of the at least two different criteria indicative of potential electrical arcing are determined by the analyzer to be present in the digital signal.

10. The invention according to claim 9 wherein the analyzer analyzes the digital signal for the presence of at least three different criteria indicative of potential electrical arcing in the alternating current power line.

11. The invention according to claim 9 wherein the analyzer analyzes the digital signal for the presence of at least four different criteria indicative of potential electrical arcing in the alternating current power line.

12. The invention according to claim 9 wherein the digital signal comprises a plurality of pulses, and analyzer analyzes a quantity of pulses occurring within a predetermined window of time to determine if the quantity of pulses meets or exceeds a predetermined threshold quantity.

13. The invention according to claim 9 wherein the digital signal comprises a plurality of pulses, and the analyzer analyzes a plurality of adjacent pulses to determine if they have substantially non-uniform pulse widths.

14. The invention according to claim 9 wherein the digital signal comprises a plurality of pulses, and the analyzer analyzes a plurality of adjacent pulses to determine if they have substantially non-uniform intervals between adjacent pulses.

15. The invention according to claim .9 wherein the digital signal comprises a plurality of pulses, and the analyzer adds durations of intervals between the plurality of adjacent pulses together to determine if an interval duration summation exceeds a predetermined threshold.

16. The invention according to claim 1, wherein the apparatus for detecting electrical arcing in an alternating current power line comprises an apparatus for detecting both electrical arcing and leakage current in an alternating current power line, the apparatus further comprising a leakage current fault detector.
